(19) United States
(12) Patent Application Publication
(10) Pub. No.: US 2024/0179382 A1
(43) Pub. Date: May 30, 2024

(54) SYSTEMS AND METHODS OF IMAGING WITH MULTI-DOMAIN IMAGE SENSOR

(71) Applicant: QUALCOMM Incorporated, San Diego, CA (US)

(72) Inventors: Prakasha NAYAK, Parkala (IN); Nikhil VERMA, Bangalore (IN)

(21) Appl. No.: 18/060,435

(22) Filed: Nov. 30, 2022

(51) Int. Cl. H04N 23/11; H04N 23/67; H04N 23/73; H04N 23/88; H04N 23/951

(52) U.S. Cl. CPC H04N 23/11; H04N 23/67; H04N 23/73; H04N 23/88; H04N 23/951

(57) ABSTRACT

Imaging systems and techniques are described. An imaging system includes a multi-domain image sensor that is sensitive to a first electromagnetic frequency domain (e.g., visible light) and a second electromagnetic frequency domain (e.g., infrared). The imaging system blends images of a scene to generate a blended image of the scene that represents the scene according to the first electromagnetic frequency domain. At least one image of the images is captured using a first image capture setting (e.g., a first ISO). The imaging system reduces pixel values in the blended image by adjustment values to generate an output image. The adjustment values are based on a representation of the scene according to a second EM frequency domain from an additional image of the scene that is captured using a second image capture setting (e.g., a second ISO).

### FIELD

This application is related to image capture and processing. More specifically, this application relates to systems and methods of using an image sensor that is configured to capture different electromagnetic frequency domains, such as visible light and infrared, including to reduce cross-domain contamination using images with domain-specific capture settings and/or image blending.

### BACKGROUND

Many devices include one or more cameras. For example, a smartphone or tablet includes a front facing camera to capture selfie images and a rear facing camera to capture an image of a scene (such as a landscape or other scenes of interest to a device user). A camera can capture images using an image sensor of the camera, which can include an array of photodetectors. Photodetectors can be sensitive to light from a given electromagnetic (EM) frequency domain, such as the visible light EM frequency domain, allowing the corresponding image sensor to capture images in the given EM frequency domain.

### BRIEF SUMMARY

In some examples, systems and techniques are described for image processing. An imaging system includes a multi-domain image sensor that is sensitive to a first electromagnetic frequency domain (e.g., visible light) and a second electromagnetic frequency domain (e.g., infrared). The imaging system blends images of a scene to generate a blended image of the scene that represents the scene according to the first electromagnetic frequency domain. At least one image of the images is captured using a first image capture setting (e.g., a first ISO). The imaging system reduces pixel values in the blended image by adjustment values to generate an output image. The adjustment values are based on a representation of the scene according to a second EM frequency domain from an additional image of the scene that is captured using a second image capture setting (e.g., a second ISO).

According to at least one example, a method is provided for determining one or more image settings. The method includes: blending a plurality of images of a scene to generate a blended image of the scene that represents the scene according to a first electromagnetic (EM) frequency domain, wherein at least one image of the plurality of images is captured using a first image capture setting; and reducing a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

In another example, an apparatus for determining one or more image settings is provided that includes at least one memory and at least one processor coupled to the at least one memory. The at least one processor is configured to: blend a plurality of images of a scene to generate a blended image of the scene that represents the scene according to a first electromagnetic (EM) frequency domain, wherein at least one image of the plurality of images is captured using a first image capture setting; and reduce a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

In another example, a non-transitory computer-readable medium is provided that has stored thereon instructions that, when executed by one or more processors, cause the one or more processors to: blend a plurality of images of a scene to generate a blended image of the scene that represents the scene according to a first electromagnetic (EM) frequency domain, wherein at least one image of the plurality of images is captured using a first image capture setting; and reduce a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

In another example, an apparatus for determining one or more image settings is provided. The apparatus includes: means for blending a plurality of images of a scene to generate a blended image of the scene that represents the scene according to a first electromagnetic (EM) frequency domain, wherein at least one image of the plurality of images is captured using a first image capture setting; and means for reducing a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

In some aspects, the first EM frequency domain includes at least a portion of a visible light EM frequency domain, and wherein the second EM frequency domain includes at least a portion of an infrared (IR) EM frequency domain. In some aspects, the first EM frequency domain includes at least a portion of an infrared (IR) EM frequency domain, and wherein the second EM frequency domain includes at least a portion of a visible light EM frequency domain.

In some aspects, the plurality of images and the additional image are captured using an image sensor. In some aspects, the image sensor includes a first set of photodetectors configured to be sensitive to the first EM frequency domain and a second set of photodetectors configured to be sensitive to the second EM frequency domain.

In some aspects, the first image capture setting includes a first ISO setting and the second image capture setting includes a second ISO setting. In some aspects, the second ISO setting is lower than the first ISO setting.

In some aspects, the plurality of images includes the at least one image and a representation of the scene according to the first EM frequency domain in the additional image. In some aspects, the at least one image of the plurality of images includes a second plurality of images captured using the first image capture setting.

In some aspects, the plurality of adjustment values are products of a coefficient and respective pixel values of the representation of the scene according to the second EM frequency domain from the additional image of the scene.

In some aspects, the first image capture setting includes a first exposure setting and the second image capture setting includes a second exposure setting. In some aspects, the first image capture setting includes a first focus setting and the second image capture setting includes a second focus setting. In some aspects, the first image capture setting includes a first white balance setting and the second image capture setting includes a second white balance setting.

In some aspects, one or more of the methods, apparatuses, and computer-readable medium described above further comprise: outputting the output image. In some aspects, one or more of the methods, apparatuses, and computer-readable medium described above further comprise: causing display of the output image using a display. In some aspects, one or more of the methods, apparatuses, and computer-readable medium described above further comprise: causing transmission of the output image to a recipient device using a communication interface.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a block diagram illustrating an example architecture an imaging system that performs an imaging process using a multi-domain image sensor, in accordance with some examples;

FIG. 3A is a perspective diagram illustrating a head-mounted display (HMD) that is used as part of an imaging system, in accordance with some examples;

FIG. 3B is a perspective diagram illustrating the head-mounted display (HMD) of FIG. 3A being worn by a user, in accordance with some examples;

FIG. 4A is a perspective diagram illustrating a front surface of a mobile handset that includes front-facing cameras and that can be used as part of an imaging system, in accordance with some examples;

FIG. 4B is a perspective diagram illustrating a rear surface of a mobile handset that includes rear-facing cameras and that can be used as part of an imaging system, in accordance with some examples;

FIG. 5 is a conceptual diagram illustrating a photodetector array of a multi-domain image sensor, in accordance with some examples;

FIG. 6 is a block diagram illustrating an example architecture an imaging system that performs an imaging process for cross-domain contamination reduction using a multi-domain image sensor that is sensitive to a first electromagnetic (EM) frequency domain and a second EM frequency domain, multiple image capture settings, and/or image blending, in accordance with some examples;

FIG. 7 is a timing diagram illustrating timing of capture of multiple image frames using a multi-domain image sensor, with corresponding dual-frame blending and cross-domain contamination reduction operations, in accordance with some examples;

FIG. 8 is a timing diagram illustrating timing of capture of multiple image frames using a multi-domain image sensor, with corresponding tri-frame blending and cross-domain contamination reduction operations, in accordance with some examples;

FIG. 9 is a flow diagram illustrating an imaging process, in accordance with some examples; and

FIG. 10 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

A camera can capture images using an image sensor of the camera, which can include an array of photodetectors. Photodetectors can be sensitive to light from a given electromagnetic (EM) frequency domain, such as the visible light EM frequency domain or the infrared (IR) EM frequency domain, allowing the corresponding image sensor to capture images in the given EM frequency domain.

In some examples, systems and techniques are described for image processing. An imaging system includes a multi-domain image sensor that is sensitive to a first electromagnetic frequency domain (e.g., visible light) and a second electromagnetic frequency domain (e.g., infrared). The imaging system blends images of a scene to generate a blended image of the scene that represents the scene according to the first electromagnetic frequency domain. At least one image of the images is captured using a first image capture setting (e.g., a first ISO). The imaging system reduces pixel values in the blended image by adjustment values to generate an output image. The adjustment values are based on a representation of the scene according to a second EM frequency domain from an additional image of the scene that is captured using a second image capture setting (e.g., a second ISO).

The imaging systems and techniques described herein provide a number of technical improvements over prior imaging systems. For instance, the imaging systems and techniques described herein provide improved image quality for systems with multi-domain image sensors, since both cross-domain contamination reduction and per-domain focus settings improve image quality. For instance, the imaging system performing cross-domain contamination reduction reduces or removes visual artifacts from images captured in each EM frequency domain caused by image data from the other EM frequency domain(s) that the image sensor is sensitive to. The imaging system generating per-domain focus settings allows the imaging system to account for differences in characteristic(s) of the different EM frequency domains, and generate separate focus settings for each EM frequency domain, improving focus for respective images captured in each EM frequency domain.

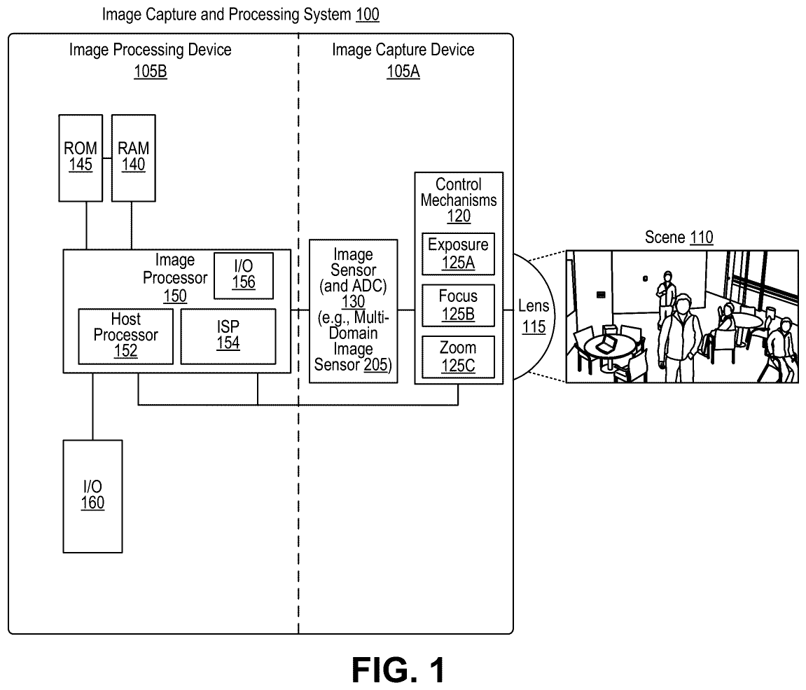

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, ISO, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

In some examples, the image sensor 130 can be a multi-domain image sensor, such as the multi-domain image sensor 205. In a multi-domain image sensor, certain photodiodes of the image sensor 130 are sensitive to a first electromagnetic (EM) frequency domain, while other photodiodes of the image sensor 130 are sensitive to a second EM frequency domain. In an illustrative example, certain photodiodes of the image sensor 130 are sensitive to the visible light EM frequency domain and other photodiodes of the image sensor 130 are sensitive to the infrared (IR) EM frequency domain. In some examples, pixel data from the photodiodes that are sensitive to the first EM frequency domain and pixel data from the photodiodes that are sensitive to the second EM frequency domain are processed together by the image processor 150. In some examples, pixel data from the photodiodes that are sensitive to the first EM frequency domain and pixel data from the photodiodes that are sensitive to the second EM frequency domain are processed separately by the image processor 150.

The image processor 150 may include one or more processors, such as one or more image signal processors (ISPs) (including ISP 154), one or more host processors (including host processor 152), and/or one or more of any other type of processor 1010 discussed with respect to the computing system 1000. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1020, read-only memory (ROM) 145 and/or 1025, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1002.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

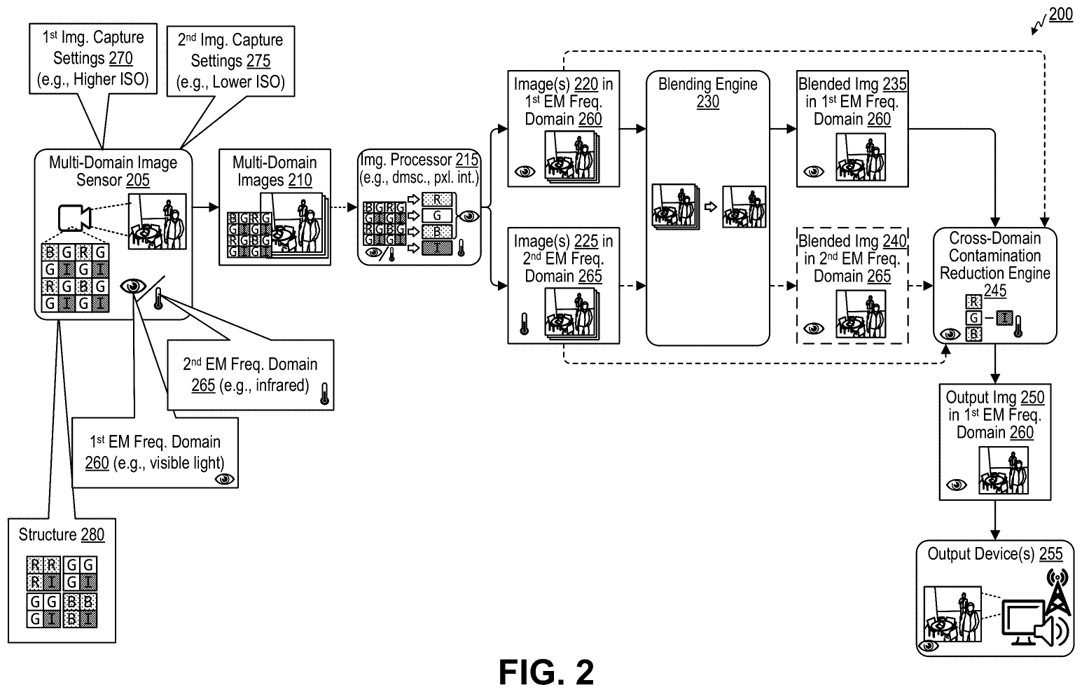

FIG. 2 is a block diagram illustrating an example architecture an imaging system 200 that performs an imaging process using a multi-domain image sensor 205. The imaging system 200 can include at least one of the image capture and processing system 100, the image capture device 105A, the image processing device 105B, the HMD 310, the mobile handset 410, the multi-domain image sensor 500, the imaging system 600, an imaging system that performs the imaging process 900, the computing system 1000, or a combination thereof. In some examples, the imaging system 200 can include, for instance, one or more laptops, phones, tablet computers, mobile handsets, video game consoles, vehicle computers, desktop computers, wearable devices, televisions, media centers, extended reality (XR) systems, virtual reality (VR) systems, augmented reality (AR) systems, mixed reality (MR) systems, head-mounted display (HMD) devices, other types of computing devices discussed herein, or combinations thereof.

The imaging system 200 includes a multi-domain image sensor 205 that captures multi-domain images 210. Examples of the multi-domain image sensor 205 include the image capture and processing system 100, the image capture device 105A, the image processing device 105B, the image sensor 130, image sensor(s) of any of cameras 330A-330D, image sensor(s) of any of cameras 430A-430D, the multi-domain image sensor 500, the dual-domain image sensor 602 that captures the dual-domain raw image data 605, an image sensor that captures the frames 705-730, an image sensor that captures the frames 805-845, an image sensor of the imaging process 900, an image sensor of an input device 1045, or a combination thereof. In some examples, the multi-domain images 210 includes raw image data, image data, pixel data, image frame(s), raw video data, video data, video frame(s), or a combination thereof.

A first portion of the multi-domain image sensor 205 is sensitive to a first electromagnetic (EM) frequency domain 260. A second portion of the multi-domain image sensor 205 is sensitive to a second EM frequency domain 265. In some examples, a third portion of the multi-domain image sensor 205 is sensitive to a third EM frequency domain, and so forth, with different portions of the image sensor sensitive to any number of different EM frequency domains. Different EM frequency domains can include, for example, the radio EM frequency domain, the microwave EM frequency domain, the infrared (IR) EM frequency domain, the visible light (VL) EM frequency domain, the ultraviolet (UV) EM frequency domain, the X-Ray EM frequency domain, the gamma ray EM frequency domain, a subset of any of these, or a combination thereof. A given portion of the multi-domain image sensor 205 can be sensitive to any of these listed EM frequency domains, subsets thereof, and/or combinations thereof. Subsets of EM frequency domains can include, for instance, different colors of visible light (e.g., red, blue, green), frequency bands within a given EM frequency domain, frequency bands spanning across at least portion(s) of two or more EM frequency domains, or combinations thereof. For instance, in some examples, the VL EM frequency domain can include red (R), green (G), blue (B), or a combination thereof. In some examples, the IR EM frequency domain can include near infrared (NIR), mid infrared (MIR), far infrared (FIR), or a combination thereof.

The multi-domain image sensor 205 includes at least one array of photodetectors. In some examples, a photodetector in the array can are covered by at least one filter that can control which EM frequency domain(s) (and/or subsets and/or combinations thereof) reach the photodetector, effectively controlling which EM frequency domain(s) (and/or subsets and/or combinations thereof) the photodetector is sensitive to. In some examples, different photodetectors in the array can be covered by different filters. In some examples, different photodetectors in the array can be sensitive to different EM frequency domain(s) (and/or subsets and/or combinations thereof), for instance based on use of filters, based on the characteristics of the photodetectors themselves, or a combination thereof. For instance, in some examples, the multi-domain image sensor 205 includes a first set of photodetectors that is sensitive to a first EM frequency domain 260 and a second set of photodetectors that is sensitive to a second EM frequency domain 265. In some examples, the multi-domain image sensor 205 additionally includes a third set of photodetectors that is sensitive to a third EM frequency domain, and so forth, with different sets of photodetectors of the image sensor sensitive to any number of different EM frequency domains.

In an illustrative example, the multi-domain image sensor 205 includes a first portion (e.g., a first set of photodetectors) that is sensitive to the visible light EM frequency domain, and a second portion (e.g., a second set of photodetectors) that is sensitive to the IR EM frequency domain. The first portion (e.g., a first set of photodetectors) can be further divided into sub-portions (e.g., subsets of the first set of photodetectors) that are sensitive to different colors (e.g., red, green, and/or blue) representing different color channels of the visible light EM frequency domain. A graphic representing the multi-domain image sensor 205 is illustrated in FIG. 2, and illustrates a camera capturing a photo of a scene with two people in a room near a laptop on a table. An exemplary portion of a photodetector array of the multi-domain image sensor 205 of the camera is illustrated as a grid, with each cell in the grid representing a photodetector that is sensitive to a particular EM frequency domain (or subset thereof) marked on the cell. Cells marked “R” are sensitive to red light from the visible light EM frequency domain. Cells marked “G” are sensitive to green light from the visible light EM frequency domain. Cells marked “B” are sensitive to blue light from the visible light EM frequency domain. Cells marked “I” are sensitive to infrared signals from the infrared EM frequency domain. The graphic also includes an icon of an eye to represent the visible light EM frequency domain, and an icon of a thermometer to represent the infrared light EM frequency domain. Within FIG. 2, a graphic representing the multi-domain images 210 illustrates a representation of an image of the scene that is depicted in the graphic representing the multi-domain image sensor 205, along with the grid representing the photodetector array of the multi-domain image sensor 205, to indicate that the multi-domain images 210 can include raw image data that is not yet demosaiced. It should be understood that the illustrative example is exemplary rather than limiting. For instance, the multi-domain image sensor 205 can include a different arrangement of photodetectors. The multi-domain image sensor 205 can be sensitive to different sets of EM frequency domains. An additional example structure 280 of another photodetector array and/or pixel array of the multi-domain image sensor 205, with 3-cell binning for different colors (red, green, and blue) and separate readout of infrared pixels and/or photodiodes.

In some examples, the multi-domain image sensor 205 can be directed toward a user (e.g., can face toward the user), and can thus capture sensor data (e.g., image data) of (e.g., depicting or otherwise representing) at least portion(s) of the user. In some examples, the multi-domain image sensor 205 can be directed away from the user (e.g., can face away from the user) and/or toward an environment that the user is in, and can thus capture sensor data (e.g., image data) of (e.g., depicting or otherwise representing) at least portion(s) of the environment. In some examples, multi-domain images 210 captured by the multi-domain image sensor 205 is directed away from the user and/or toward the user. In some examples, multi-domain images 210 captured by the multi-domain image sensor 205 is can have a field of view (FoV) that includes, is included by, overlaps with, and/or otherwise corresponds to, a FoV of the eyes of the user.

In some examples, imaging system 200 can also include one or more other sensors in addition to the multi-domain image sensor 205, such as one or more other cameras, other image sensors, microphones, heart rate monitors, oximeters, biometric sensors, positioning receivers, Global Navigation Satellite System (GNSS) receivers, Inertial Measurement Units (IMUs), accelerometers, gyroscopes, gyrometers, barometers, thermometers, altimeters, depth sensors, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, other sensors discussed herein, or combinations thereof. In some examples, the one or more sensors 205 include at least one input device 1045 of the computing system 1000. In some implementations, one or more of these additional sensor(s) may complement or refine sensor readings from the multi-domain image sensor 205. For example, Inertial Measurement Units (IMUs), accelerometers, gyroscopes, or other sensors may be used to identify a pose (e.g., position and/or orientation) and/or motion(s) and/or acceleration(s) of the imaging system 200 and/or of the user in the environment, which can be used by the imaging system 200 to reduce motion blur, rotation blur, or combinations thereof.

The imaging system 200 passes the multi-domain images 210 from the multi-domain image sensor 205 to an image processor 215. The image processor 215 can include the image processing device 105B, the image processor 150, the host processor 152, the ISP 154, a demosaicing engine, a pixel interpolator, the computing system 1000, the processor 1010, or a combination thereof. The image processor 215 can demosaic and/or perform pixel interpolation on the multi-domain images 210. The image processor 215 can perform other image processing operations, such as adjusting brightness, saturation, noise reduction, sharpness, contrast, luminosity, white balance, black balance, and/or other attributes of the multi-domain images 210. In some examples, the image processor 215 can demosaic and/or perform pixel interpolation on the multi-domain images 210 to generate a first set of image(s) 220 of the scene and a second set of image(s) 225 of the scene. The first set of image(s) 220 of the scene depict and/or represent the scene according to the first EM frequency domain 260 (e.g., visible light), and the image processor 215 generates the first set of image(s) 220 using the pixel data detected by the photodiodes of the multi-domain image sensor 205 that are sensitive to the first EM frequency domain 260. The second set of image(s) 225 of the scene depict and/or represent the scene according to the second EM frequency domain 265 (e.g., infrared (IR)), and the image processor 215 generates the second set of image(s) 225 using the pixel data detected by the photodiodes of the multi-domain image sensor 205 that are sensitive to the second EM frequency domain 265.

In an illustrative example, to generate the first set of image(s) 220, the image processor 215 can demosaic the multi-domain images 210 using only the image data from the photodetectors sensitive to the first EM frequency domain 260, ignoring or skipping image data from the photodetectors sensitive to the second EM frequency domain 265. The image processor 215 can use pixel interpolation to fill in the gaps in the image caused by ignoring or skipping image data from the photodetectors sensitive to the second EM frequency domain 265. In an illustrative example, to generate the second set of image(s) 225, the image processor 215 can demosaic the multi-domain images 210 using only the image data from the photodetectors sensitive to the second EM frequency domain 265, ignoring or skipping image data from the photodetectors sensitive to the first EM frequency domain 260. In some examples, the image processor 215 can use pixel interpolation to fill in the gaps in the image caused by ignoring or skipping image data from the photodetectors sensitive to the first EM frequency domain 260.

In some situations, for instance in low-light scenes, the images in the first set of image(s) 220 and/or the second set of image(s) 225 may be noisy, with signal-to-noise ratio (SNR) below a threshold. The imaging system 200 includes a blending engine 230 that can blend multiple images of a scene (e.g., different video frames in a video of the scene) into a blended image to reduce noise (e.g., increasing SNR) by aligning the images and using an average (e.g., mean, median, mode, maximum, minimum) of the pixel values for each pixel location for the blended pixel in that pixel location in the blended image. Such blending can also improve lighting in the blended image if the different images are captured using different image capture settings (e.g., first image capture settings 270 and second image capture settings 275), for instance with different ISO settings, different exposure settings, different aperture settings, different white balance settings, different focus settings, or other image capture settings discussed herein. In particular, the blending engine 230 can blend the first set of image(s) 220 in the first EM frequency domain 260 to generate the blended image 235 in the first EM frequency domain 260. Similarly, the blending engine 230 can blend the second set of image(s) 225 in the second EM frequency domain 265 to generate the blended image 240 in the second EM frequency domain 265. In some examples, some of the first set of image(s) 220 are captured using the first image capture settings 270, while some of the first set of image(s) 220 are captured using second image capture settings 275. In some examples, some of the second set of image(s) 225 are captured using the first image capture settings 270, while some of the second set of image(s) 225 are captured using second image capture settings 275. A graphic representing the blending engine 230 is illustrated in FIG. 2, and illustrates a stack of multiple images being converted into a single blended image.

In some situations, when multi-domain images 210 are processed using the image processor 215 to only use image data from a first EM frequency domain 260 that the multi-domain image sensor 205 is sensitive to as discussed above, the resulting image(s) generated by the image processor 215 (e.g., the first set of image(s) 220, the second set of image(s) 225, the blended image 235, and/or the blended image 240) can include image artifacts. The image artifacts in images in the first EM frequency domain 260 (e.g., the first set of image(s) 220 and/or the blended image 235) can be caused by contamination from a second EM frequency domain 265 that the multi-domain image sensor 205 is also sensitive to, and vice versa. These visual artifacts can include false colors and/or chromatic aberration(s), and can appear particularly at or around sharp edges in the image. This contamination, and/or these image artifacts, can be referred to as cross-domain contamination. The imaging system 200 includes a cross-domain contamination reduction engine 245 that can perform cross-domain contamination reduction on the first set of image(s) 220 and/or the blended image 235 using the second set of image(s) 225 and/or a blended image 240 to generate an output image 250. Cross-domain contamination reduction can reduce contamination from of image data from one EM frequency domain captured by the multi-domain image sensor 205 on image data from another EM frequency domain captured by the multi-domain image sensor 205. In some examples, cross-domain contamination reduction can entail multiplying a pixel data value of the contaminating EM frequency domain in a location or area of the image by a coefficient (e.g., a constant), and subtracting the product from a pixel data value of a target EM frequency domain in the location or area of the image. A graphic representing the cross-domain contamination reduction engine 245 is illustrated in FIG. 2, and illustrates a infrared data from an infrared pixel being subtracted from red, green, and blue pixel data.

In an illustrative example, the first EM frequency domain 260 is the visible light EM frequency domain (e.g., which may be further subdivided into colors such as red, green, and blue), the second EM frequency domain 265 is the infrared (IR) EM frequency domain, and the cross-domain contamination reduction engine 245 performs cross-domain contamination reduction on the first set of image(s) 220 and/or the blended image 235 using the second set of image(s) 225 and/or a blended image 240 to generate an output image 250 according to the following equations:

R=R_{contaminated}−α·IR Equation 1

G=G_{contaminated}−b·IR Equation 2

B=B_{contaminated}−C·IR Equation 3

In Equation 1 above, R represents a value of the red color channel in a pixel of the output image 250, R_{contaminated} represents a value of the red color channel in a corresponding pixel of the first set of image(s) 220 and/or the blended image 235, a represents a first coefficient, and IR represents a value of at least one corresponding infrared pixel in the second set of image(s) 225 and/or the blended image 240. The position of the pixel with the red color channel value R in the frame of the output image 250 can match the position of the pixel with the red color channel value R_{contaminated} in the frame of the first set of image(s) 220 and/or the blended image 235. The position of the infrared pixel with the value IR in the frame of the second set of image(s) 225 and/or the blended image 240 can match, be adjacent to, or be within a threshold distance of the positions of the pixel with the red color channel values R and R_{contaminated} in the respective frames of the output image 250 and the first set of image(s) 220 and/or the blended image 235. In some examples, the value IR is a combination (e.g., an average or a weighted average weighed by distance) of multiple infrared pixels whose positions in the in the frame of the second set of image(s) 225 and/or the blended image 240 are adjacent to or within the threshold distance of the positions of the pixel with the red color channel values R and R_{contaminated} in the respective frames of the output image 250 and the first set of image(s) 220 and/or the blended image 235.

Similarly, in Equation 2 above, G represents a value of the green color channel in a pixel of the output image 250, G_{contaminated} represents a value of the green color channel in a corresponding pixel of the first set of image(s) 220 and/or the blended image 235, b represents a second coefficient, and IR represents a value of at least one corresponding infrared pixel in the second set of image(s) 225 and/or the blended image 240. The position of the pixel with the green color channel value (in the frame of the output image 250 can match the position of the pixel with the green color channel value G_{contaminated} in the frame of the first set of image(s) 220 and/or the blended image 235. The position(s) of the infrared pixel(s) with the value IR in the frame of the second set of image(s) 225 and/or the blended image 240 can match, be adjacent to, or be within a threshold distance of the positions of the pixel with the green color channel values G and G_{contaminated} in the respective frames of the output image 250 and the first set of image(s) 220 and/or the blended image 235. In some examples, the value IR is a combination (e.g., an average or a weighted average weighed by distance) of multiple infrared pixels whose positions in the in the frame of the second set of image(s) 225 and/or the blended image 240 are adjacent to or within the threshold distance of the positions of the pixel with the green color channel values G and G_{contaminated} in the respective frames of the output image 250 and the first set of image(s) 220 and/or the blended image 235.

In Equation 3 above, B represents a value of the blue color channel in a pixel of the output image 250, B_{contaminated} represents a value of the blue color channel in a corresponding pixel of the first set of image(s) 220 and/or the blended image 235, c represents a third coefficient, and IR represents a value of at least one corresponding infrared pixel in the second set of image(s) 225 and/or the blended image 240. The position of the pixel with the blue color channel value B in the frame of the output image 250 can match the position of the pixel with the blue color channel value B_{contaminated} in the frame of the first set of image(s) 220 and/or the blended image 235. The position(s) of the infrared pixel(s) with the value IR in the frame of the second set of image(s) 225 and/or the blended image 240 can match, be adjacent to, or be within a threshold distance of the positions of the pixel with the blue color channel values B and B_{contaminated} in the respective frames of the output image 250 and the first set of image(s) 220 and/or the blended image 235. In some examples, the value IR is a combination (e.g., an average or a weighted average weighed by distance) of multiple infrared pixels whose positions in the in the frame of the second set of image(s) 225 and/or the blended image 240 are adjacent to or within the threshold distance of the positions of the pixel with the blue color channel values B and B_{contaminated} in the respective frames of the output image 250 and the first set of image(s) 220 and/or the blended image 235.

In some examples, the values of the three coefficients a, b, and c are distinct from one another. In some examples, the values of at least two of the three coefficients (a, b, and c) match. In some examples, values for the constants a, b, and/or c can range from 0 to 1, for instance including 0.0, 0.1, 0.2, 0.3, 0.4, 0.5, 0.6, 0.7, 0.8, 0.9, 1.0, or a value in between any of the listed values. In some examples, values for the constants a, b, and/or c can exceed 1. In some examples, values for the constants a, b, and/or c can be different from one another. In some examples, values for two or more of the constants a, b, and/or c can be equal to one another.

In some examples, at least some of the image data in the first EM frequency domain 260 is captured using the first image capture settings 270, while at least some of the image data in the second EM frequency domain 265 is captured using the second image capture settings 275. In some examples, the first image capture settings 270 include a higher ISO than the second image capture settings 275, which may include a lower ISO. In some examples, image capture settings that are set to work well in the first EM frequency domain 260 do not necessarily work well in the second EM frequency domain 265, and vice versa, hence the difference. Furthermore, in some examples, different EM frequency domains may work better for different scene lighting conditions. For instance, for a bright scene, images in the visible light EM frequency domain can work well, while images in the IR EM frequency domain can appear washed out and/or overexposed. On the other hand, for a dark scene, images in the IR EM frequency domain can work well, while images in the visible light EM frequency domain can appear dark and noisy. Use of different image capture settings (e.g., different ISOs) can optimize image capture setting (e.g., ISOs) for the different EM frequency domains. Use of different image capture settings (e.g., different ISOs) can also prevent the cross-domain contamination reduction engine 245 from overcorrecting or introducing visual artifacts. For instance, for dark scenes where the IR EM frequency domain works well, subtracting adjustment values based on the IR EM frequency domain from visible light pixels can remove more visual data than intended, which can result in muffled, muted, or desaturated colors in the output image 250. Use of the different image capture settings (e.g., different ISOs) can reduce this issue.

In some examples, the cross-domain contamination reduction engine 245 also performs remoasicing to generate the output image 250 in the first EM frequency domain 260. Remoasicing can include moving the pixel data into a new pixel mosaic that does not include the pixels from the omitted EM frequency domain. For instance, the new mosaic for the output image does not include the pixels from the second EM frequency domain 265.

The imaging system 200 includes output device(s) 255. The output device(s) 255 can include one or more visual output devices, such as display(s) or connector(s) therefor. The output device(s) 255 can include one or more audio output devices, such as speaker(s), headphone(s), and/or connector(s) therefor. The output device(s) 255 can include one or more of the output device 1035 and/or of the communication interface 1040 of the computing system 1000. In some examples, the imaging system 200 causes the display(s) of the output device(s) 255 to display the output image 250. In some examples, the imaging system 200 causes the display(s) of the output device(s) 255 to display the output image 250 in the first EM frequency domain 260.

In some examples, the output device(s) 255 include one or more transceivers. The transceiver(s) can include wired transmitters, receivers, transceivers, or combinations thereof. The transceiver(s) can include wireless transmitters, receivers, transceivers, or combinations thereof. The transceiver(s) can include one or more of the output device 1035 and/or of the communication interface 1040 of the computing system 1000. In some examples, the imaging system 200 causes the transceiver(s) to send, to a recipient device, the output image 250. In some examples, the recipient device can include another imaging system 200, an HMD 310, a mobile handset 410, a computing system 1000, or a combination thereof. In some examples, the recipient device can include a display, and the data sent to the recipient device from the transceiver(s) of the output device(s) 255 can cause the display of the recipient device to display the output image 250.

In some examples, the display(s) of the output device(s) 255 of the imaging system 200 function as optical “see-through” display(s) that allow light from the real-world environment (scene) around the imaging system 200 to traverse (e.g., pass) through the display(s) of the output device(s) 255 to reach one or both eyes of the user. For example, the display(s) of the output device(s) 255 can be at least partially transparent, translucent, light-permissive, light-transmissive, or a combination thereof. In an illustrative example, the display(s) of the output device(s) 255 includes a transparent, translucent, and/or light-transmissive lens and a projector. The display(s) of the output device(s) 255 of can include a projector that projects virtual content (e.g., the output image 250) onto the lens. The lens may be, for example, a lens of a pair of glasses, a lens of a goggle, a contact lens, a lens of a head-mounted display (HMD) device, or a combination thereof. Light from the real-world environment passes through the lens and reaches one or both eyes of the user. The projector can project virtual content (e.g., the output image 250) onto the lens, causing the virtual content to appear to be overlaid over the user's view of the environment from the perspective of one or both of the user's eyes. In some examples, the projector can project the virtual content onto the onto one or both retinas of one or both eyes of the user rather than onto a lens, which may be referred to as a virtual retinal display (VRD), a retinal scan display (RSD), or a retinal projector (RP) display.

In some examples, the display(s) of the output device(s) 255 of the imaging system 200 are digital “pass-through” display that allow the user of the imaging system 200 and/or a recipient device to see a view of an environment by displaying the view of the environment on the display(s) of the output device(s) 255. The view of the environment that is displayed on the digital pass-through display can be a view of the real-world environment around the imaging system 200, for example based on sensor data (e.g., images, videos, depth images, point clouds, other depth data, or combinations thereof) captured by the multi-domain image sensor 205 (e.g., multi-domain images 210 and/or output image 250) and/or other sensors described herein. The view of the environment that is displayed on the digital pass-through display can be a virtual environment (e.g., as in VR), which may in some cases include elements that are based on the real-world environment (e.g., boundaries of a room). The view of the environment that is displayed on the digital pass-through display can be an augmented environment (e.g., as in AR) that is based on the real-world environment. The view of the environment that is displayed on the digital pass-through display can be a mixed environment (e.g., as in MR) that is based on the real-world environment. The view of the environment that is displayed on the digital pass-through display can include virtual content (e.g., the output image 250) overlaid over other otherwise incorporated into the view of the environment.

Within FIG. 2, a graphic representing the output device(s) 255 illustrates a display, a speaker, and a wireless transceiver, outputting the first image illustrated in the graphics representing the multi-domain image sensor 205, the multi-domain images 210, the image processor 215, and the output image 250, with an eye icon representing that the output device(s) 255 are configured to output the output image 250 associated with an EM frequency domain (e.g., the first EM frequency domain 260 and/or the second EM frequency domain 265).

It should be understood that references herein to the multi-domain image sensor 205, and other sensors described herein, as images sensors should be understood to also include other types of sensors that can produce outputs in image form, such as depth sensors that produce depth images and/or point clouds that can be expressed in image form and/or rendered images of 3D models (e.g., RADAR, LIDAR, SONAR, SODAR, ToF, structured light). It should be understood that references herein to image data, and/or to images, produced by such sensors can include any sensor data that can be output in image form, such as depth images, point clouds that can be expressed in image form, and/or rendered images of 3D models.

In some examples, certain elements of the imaging system 200 (e.g., the multi-domain image sensor 205, the image processor 215, the blending engine 230, the cross-domain contamination reduction engine 245, the output device(s) 255, or a combination thereof) include a software element, such as a set of instructions corresponding to a program, that is run on a processor such as the processor 1010 of the computing system 1000, the image processor 150, the host processor 152, the ISP 154, or a combination thereof. In some examples, one or more of these elements of the imaging system 200 can include one or more hardware elements, such as a specialized processor (e.g., the processor 1010 of the computing system 1000, the image processor 150, the host processor 152, the ISP 154, or a combination thereof). In some examples, one or more of these elements of the imaging system 200 can include a combination of one or more software elements and one or more hardware elements.

In some examples, each visible light channel (e.g., R, G, B) has an additional transmittance peak overlapping with the IR channel to increase light throughput at night. During daylight, IR channel can be subtracted from each RGB channel to produce a color image. However, at night, IR is dominant, can subtracting out the IR channel can cause muffled, muted, or desaturated colors. During low light, the imaging system 200 can increase the ISO value to have stronger RGB signals, while the IR frame is captured at lower ISO. RGB values from two or more frames can be blended to reduce noise.

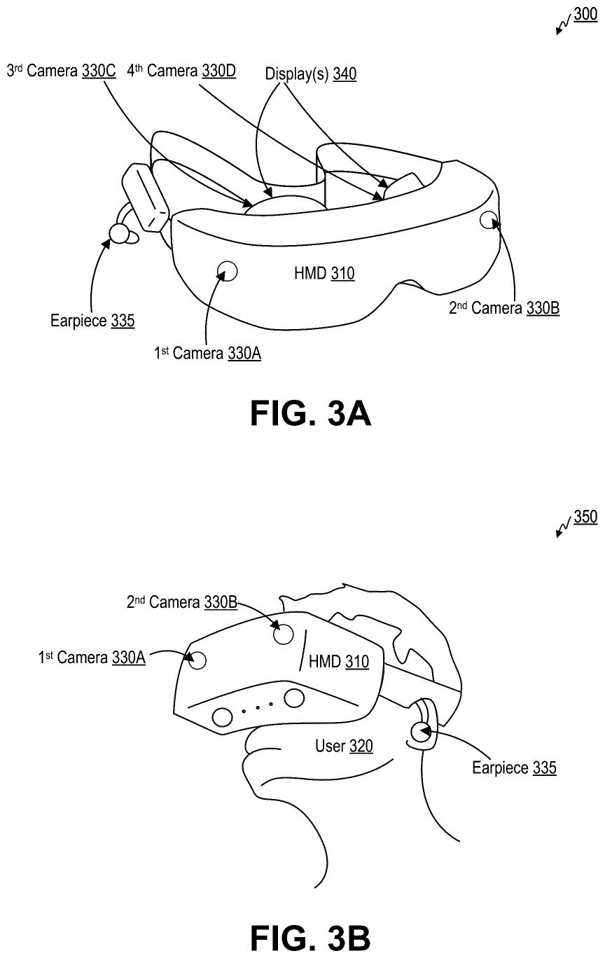

FIG. 3A is a perspective diagram 300 illustrating a head-mounted display (HMD) 310 that is used as part of an imaging system 200. The HMD 310 may be, for example, an augmented reality (AR) headset, a virtual reality (VR) headset, a mixed reality (MR) headset, an extended reality (XR) headset, or some combination thereof. The HMD 310 may be an example of an imaging system 200. The HMD 310 includes a first camera 330A and a second camera 330B along a front portion of the HMD 310. The first camera 330A and the second camera 330B may be examples of the multi-domain image sensor 205 of the imaging system 200. The HMD 310 includes a third camera 330C and a fourth camera 330D facing the eye(s) of the user as the eye(s) of the user face the display(s) 340. The third camera 330C and the fourth camera 330D may be examples of the multi-domain image sensor 205 of the imaging system 200. In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of multi-domain image sensor 205 of the imaging system 200. In some examples, the first camera 330A, the second camera 330B, third camera 330C, and/or the fourth camera 330D may be examples of the image capture and processing system 100, the image capture device 105A, the image processing device 105B, or a combination thereof.

The HMD 310 may include one or more displays 340 that are visible to a user 320 wearing the HMD 310 on the user 320's head. The one or more displays 340 of the HMD 310 can be examples of the one or more displays of the output device(s) 255 of the imaging system 200. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310, and may be examples of output device(s) 255. One earpiece 335 is illustrated in FIGS. 3A and 3B, but it should be understood that the HMD 310 can include two earpieces, with one earpiece for each ear (left ear and right ear) of the user. In some examples, the HMD 310 can also include one or more microphones (not pictured). In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include the output image 250. The output images can be based on the images captured by the first camera 330A and the second camera 330B (e.g., the multi-domain images 210 and/or the output image 250), for example with the virtual content (e.g., output image 250) overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an ear of the user 320. The HMD 310 may be outputting audio to the user 320 through the earpiece 335 and/or through another earpiece (not pictured) of the HMD 310 that is in the other ear (not pictured) of the user 320.

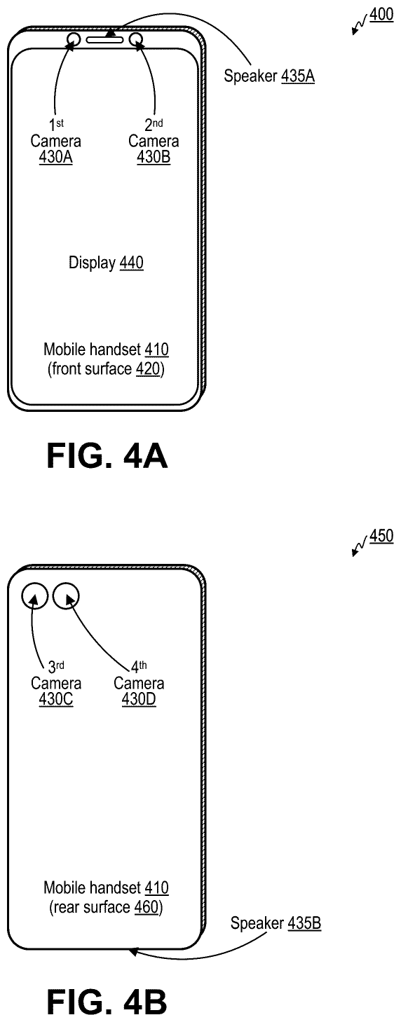

FIG. 4A is a perspective diagram 400 illustrating a front surface of a mobile handset 410 that includes front-facing cameras and can be used as part of an imaging system 200. The mobile handset 410 may be an example of an imaging system 200. The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the multi-domain image sensor 205 of the imaging system 200. The first camera 430A and the second camera 430B can face the user, including the eye(s) of the user, while content (e.g., the multi-domain images 210 and/or the output image 250) is displayed on the display 440. The display 440 may be an example of the display(s) of the output device(s) 255 of the imaging system 200.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the display 440 of the mobile handset 410 displays one or more output images toward the user using the mobile handset 410. In some examples, the output images can include the output image 250. The output images can be based on the images (e.g., the multi-domain images 210 and/or the output image 250) captured by the first camera 430A, the second camera 430B, the third camera 430C, and/or the fourth camera 430D, for example with the virtual content (e.g., output image 250) overlaid.

In some examples, the front surface 420 of the mobile handset 410 may include one or more additional cameras in addition to the first camera 430A and the second camera 430B. The one or more additional cameras may also be examples of the multi-domain image sensor 205 of the imaging system 200. In some examples, the front surface 420 of the mobile handset 410 may include one or more additional sensors in addition to the first camera 430A and the second camera 430B. The one or more additional sensors may also be examples of the multi-domain image sensor 205 of the imaging system 200. In some cases, the front surface 420 of the mobile handset 410 includes more than one display 440. The one or more displays 440 of the front surface 420 of the mobile handset 410 can be examples of the display(s) of the output device(s) 255 of the imaging system 200. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). In some examples, the mobile handset 410 can include one or more microphones along and/or adjacent to the front surface 420 of the mobile handset 410, with these microphones being examples of the multi-domain image sensor 205 of the imaging system 200. In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as part of an imaging system 200. The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the multi-domain image sensor 205 of the imaging system 200. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the multi-domain image sensor 205 of the imaging system 200. In some examples, the rear surface 460 of the mobile handset 410 may include one or more additional sensors in addition to the third camera 430C and the fourth camera 430D. The one or more additional sensors may also be examples of the multi-domain image sensor 205 of the imaging system 200. In some examples, the first camera 430A, the second camera 430B, third camera 430C, and/or the fourth camera 430D may be examples of the image capture and processing system 100, the image capture device 105A, the image processing device 105B, or a combination thereof.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). In some examples, the mobile handset 410 can include one or more microphones along and/or adjacent to the rear surface 460 of the mobile handset 410, with these microphones being examples of the multi-domain image sensor 205 of the imaging system 200. In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images, such as the output image 250. The output images can be based on the images (e.g. the multi-domain images 210 and/or the output image 250) captured by the third camera 430C and/or the fourth camera 430D, for example with the virtual content (e.g., output image 250) overlaid. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

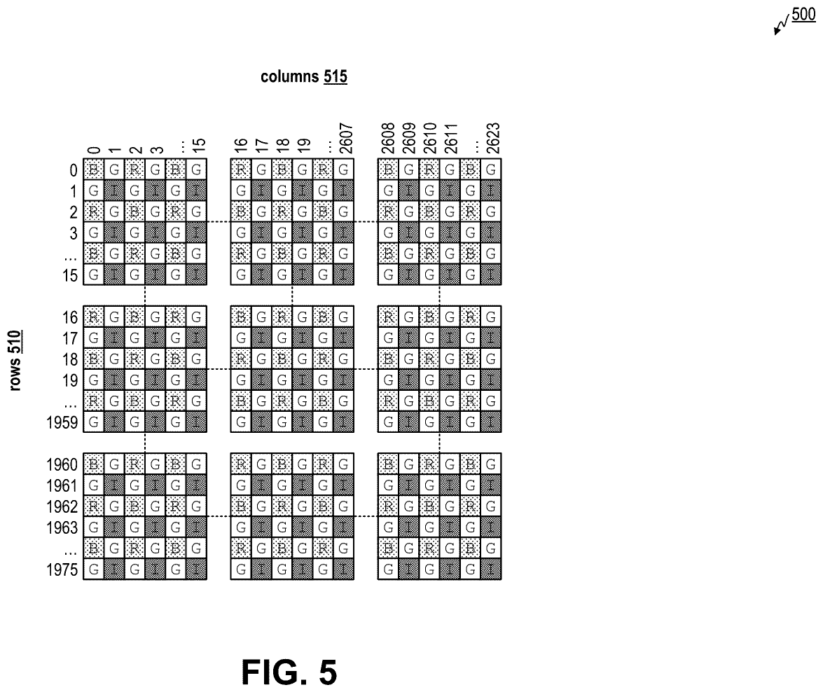

FIG. 5 is a conceptual diagram illustrating a photodetector array of a multi-domain image sensor 500. The multi-domain image sensor 500 is an example of the multi-domain image sensor 205 of the imaging system 200. The photodetector array of the multi-domain image sensor 500 is illustrated as a grid divided into 9176 rows 510 and 2624 columns 515. Each cell in the grid represents a photodetector that is sensitive to a particular EM frequency domain (or subset thereof) marked on the cell. Cells marked “R” are sensitive to red light from the visible light EM frequency domain. Cells marked “G” are sensitive to green light from the visible light EM frequency domain. Cells marked “B” are sensitive to blue light from the visible light EM frequency domain. Cells marked “I” are sensitive to infrared signals from the infrared EM frequency domain. The photodetectors that are sensitive to red, green, and blue are sensitive to the visible light EM frequency domain, which may be a first EM frequency domain of the multiple EM frequency domains that the multi-domain image sensor 500 is sensitive to. The photodetectors that are sensitive to IR are sensitive to the IR EM frequency domain, which may be a second EM frequency domain of the multiple EM frequency domains that the multi-domain image sensor 500 is sensitive to.

The multi-domain image sensor 500 can include a number of active lines (e.g., 9144 or other number of active lines) for reading photodetector data from the multi-domain image sensor 500, for instance to capture the multi-domain images 210 using the multi-domain image sensor 500. In some cases, the multi-domain image sensor 500 can include a number of “active dummy” lines (e.g., 32 or other number of active dummy lines) for reading “dummy” photodetector data. For instance, the “dummy” photodetector data can be used to detect and/or correct leakage current, for image stabilization, for PDAF, for CDAF, for calibration, and/or for other purposes. In some cases, the “dummy” photodetector data is included in the multi-domain images 210. In some examples, the “dummy” photodetector data is excluded in the multi-domain images 210.

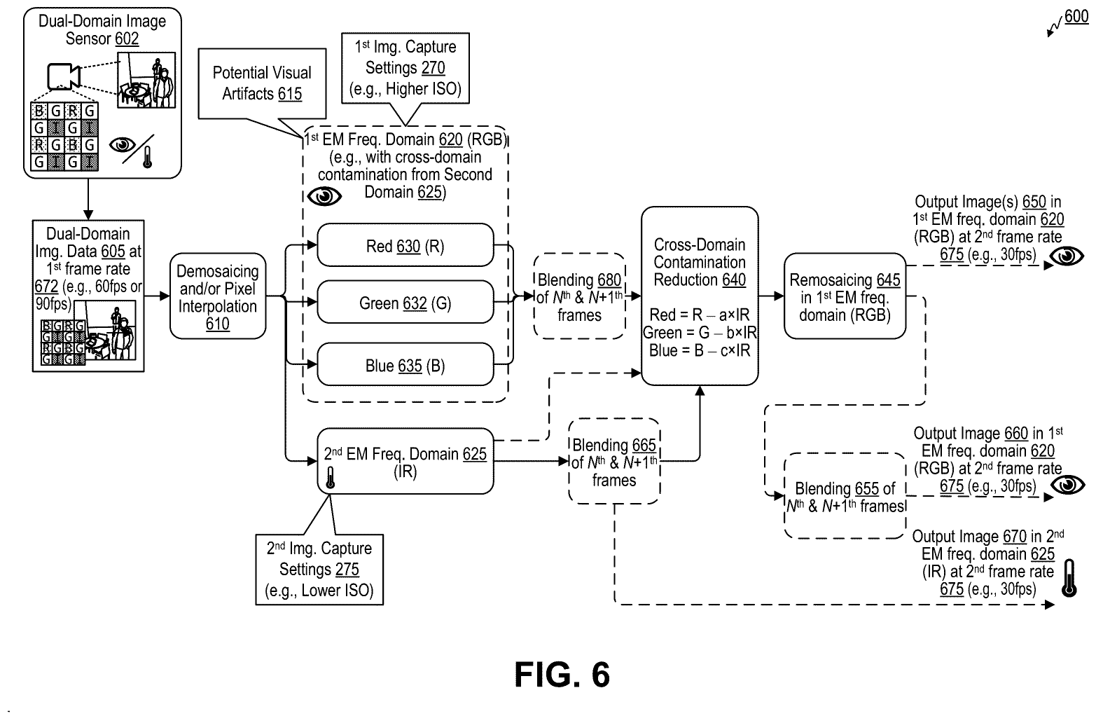

FIG. 6 is a block diagram illustrating an example architecture an imaging system 600 that performs an imaging process using a multi-domain image sensor that is sensitive to a first electromagnetic (EM) frequency domain 620 and a second EM frequency domain 625, multiple image capture settings, and/or image blending. The imaging system captures dual-domain raw image data 605 using a dual-domain image sensor 602. The dual-domain image sensor 602 is an example of the multi-domain image sensor 205 that is sensitive to the first EM frequency domain 620 and the second EM frequency domain 625. The dual-domain raw image data 605 is an example of the multi-domain images 210 that includes photodetector data from a first set of photodetectors sensitive to the first EM frequency domain 620 and photodetector data from a second set of photodetectors sensitive to the second EM frequency domain 625.

The imaging system 600 (e.g., an image processor 215 of the imaging system 600) performs demosaicing and/or pixel interpolation 610 on the dual-domain raw image data 605 to divide the dual-domain raw image data 605 into single-domain images associated with the first EM frequency domain 620 and the second EM frequency domain 625, respectively. In the illustrated example of FIG. 6, the first EM frequency domain 620 is the visible light EM frequency domain, and includes sub-domains red 630 (R), green 632 (G), and blue 635 (B). In the illustrated example of FIG. 6, the second EM frequency domain 625 is the IR EM frequency domain.

In some examples, at least some of the image data in the first EM frequency domain 620 is captured using the first image capture settings 270, while at least some of the image data in the second EM frequency domain 625 is captured using the second image capture settings 275. In some examples, the first image capture settings 270 include a higher ISO than the second image capture settings 275, which may include a lower ISO. For instance, in some examples, the dual-domain image sensor 602 can be configured so that different image capture settings can be set for different photodiodes and/or pixels, allowing the first image capture settings 270 to be set for the pixels in the first EM frequency domain 620, and the second image capture settings 275 to be set for the pixels in the second EM frequency domain 625, even in the same image. In some examples, the dual-domain image data 605 can include multiple images captured one after another (e.g., as in video frames of a video), where different image capture settings are set for the different images. To use image data with different image capture settings for the different EM frequency domains, the imaging system 600 can use image data from one frame (e.g., a frame N) for the image data captured using the first image capture settings 270 (e.g., for the first EM frequency domain 620) and can use image data from a different frame (e.g., a frame N+1 or N−1) for the image data captured using the second image capture settings 275 (e.g., for the second EM frequency domain 625).

The imaging system 600 (e.g., the blending engine 230) can generate a blended image 680 from multiple images of the first EM frequency domain 620 (e.g., at least one of which is captured at the first image capture settings 270). The imaging system 600 (e.g., the blending engine 230) can generate a blended image 665 from multiple images of the second EM frequency domain 625 (e.g., at least one of which is captured at the second image capture settings 275).

The imaging system 600 (e.g., the cross-domain contamination reduction engine 245) performs cross-domain contamination reduction to reduce potential visual artifacts 615 from cross-domain contamination, such as false colors and/or chromatic aberration(s) that can appear particularly at or around sharp edges in the image. The imaging system 600 (e.g., the cross-domain contamination reduction engine 245) performs cross-domain contamination reduction 640 on the single-domain image data from the first EM frequency domain 620 and/or the blended image 680 using the image data from the second EM frequency domain 625 and/or the blended image 665 to generate the output image(s) 650 in the first EM frequency domain 620, for instance as discussed previously with respect to the cross-domain contamination reduction engine 245. For instance, to remove cross-domain contamination from the second EM frequency domain 625 (IR) from a single-domain image from the first EM frequency domain 620 (VL), a pixel data value from a given IR-sensitive photodetector can be multiplied by a coefficient, and the product can be subtracted from the pixel data value from a VL-sensitive photodetector that is adjacent to the IR-sensitive photodetector. Different coefficients can be used for different colors or subsets of an EM frequency domain.

In some examples, the imaging system 600 (e.g., the blending engine 230) performs further blending 655 of the output image(s) 650 (e.g., associated with different frames) to generate a blended output image 660 in the first EM frequency domain 620. In some examples, the imaging system 600 (e.g., the blending engine 230) can output the blended image 665 as an output image 670 in the second EM frequency domain 625.

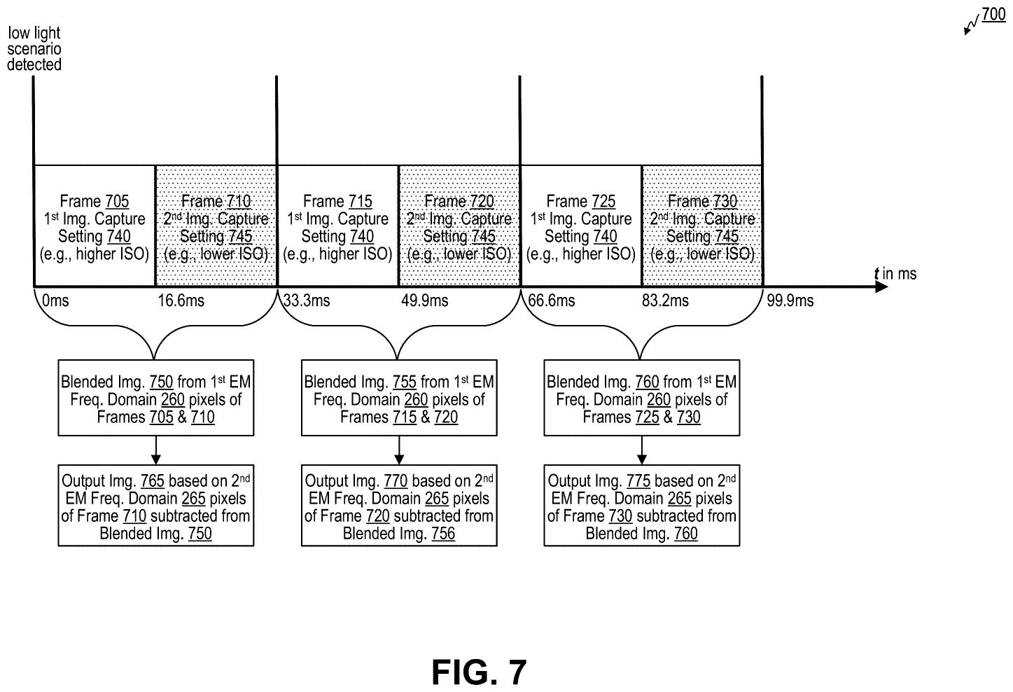

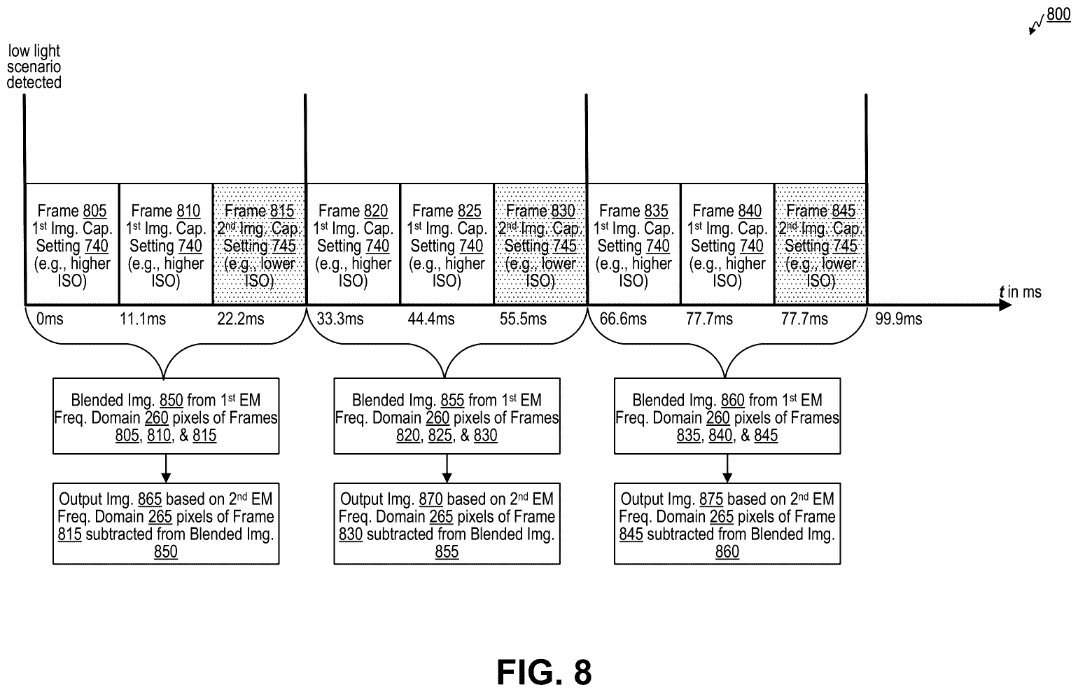

In some examples, the imaging system 600 can capture the dual-domain raw image data 605 at a first frame rate, such as 60 frames per second (fps) (e.g., see FIG. 7) or 90 fps (e.g., see FIG. 8). Based on the blending by the imaging system 600 (e.g., of blended image 680, blended image 665, ad/or blending 655) the output image(s) 650, the output image 660, and/or the output image 670 may be output at a second frame rate 675 (e.g., 30 fps) that is lower than the first frame rate 672.

FIG. 7 is a timing diagram 700 illustrating timing of capture of multiple image frames using a multi-domain image sensor, with corresponding dual-frame blending and cross-domain contamination reduction operations. The timing diagram shows capture of various image frames by a multi-domain image sensor (e.g., image sensor 130, multi-domain image sensor 205, dual-domain image sensor 602) along a time axis (1) measured in milliseconds (ms). The image frames include an image frame 705 captured at 0 ms according to a first capture setting 740 (e.g., having a higher ISO), an image frame 710 captured at 16.6 ms according to a second capture setting 745 (e.g., having a lower ISO), an image frame 715 captured at 33.3 ms according to the first capture setting 740, an image frame 720 captured at 49.9 ms according to a second capture setting 745, an image frame 725 captured at 66.6 ms according to the first capture setting 740, and an image frame 730 captured at 83.2 ms according to a second capture setting 745. In some examples, the image frames may be captured by the multi-domain image sensor after detection of a low-light scenario (scene) by the multi-domain image sensor (e.g., by an image processor 150 configured to adjust autofocus, autoexposure, and/or auto-white-balance).

An imaging system (e.g., the blending engine 230) generates a blended image 750 from the pixels in the first EM frequency domain 260 of the image frame 705 and the image frame 710. The imaging system (e.g., the cross-domain contamination reduction engine 245) generates an output image 765 by subtracting adjustment values (that are based on the pixel values in the second EM frequency domain 265 of the image frame 710) from the pixel values of the blended image 750.

The imaging system (e.g., the blending engine 230) generates a blended image 755 from the pixels in the first EM frequency domain 260 of the image frame 715 and the image frame 720. The imaging system (e.g., the cross-domain contamination reduction engine 245) generates an output image 770 by subtracting adjustment values (that are based on the pixel values in the second EM frequency domain 265 of the image frame 720) from the pixel values of the blended image 755.

The imaging system (e.g., the blending engine 230) generates a blended image 760 from the pixels in the first EM frequency domain 260 of the image frame 725 and the image frame 730. The imaging system (e.g., the cross-domain contamination reduction engine 245) generates an output image 775 by subtracting adjustment values (that are based on the pixel values in the second EM frequency domain 265 of the image frame 730) from the pixel values of the blended image 760.

FIG. 8 is a timing diagram 800 illustrating timing of capture of multiple image frames using a multi-domain image sensor, with corresponding tri-frame blending and cross-domain contamination reduction operations. The timing diagram shows capture of various image frames by a multi-domain image sensor (e.g., image sensor 130, multi-domain image sensor 205, dual-domain image sensor 602) along a time axis (1) measured in milliseconds (ms). The image frames include an image frame 805 captured at 0 ms according to a first capture setting 740 (e.g., having a higher ISO), an image frame 810 captured at 11.1 ms according to the first capture setting 740, an image frame 815 captured at 22.2 ms according to a second capture setting 745 (e.g., having a lower ISO), an image frame 820 captured at 33.3 ms according to the first capture setting 740, an image frame 825 captured at 44.4 ms according to the first capture setting 740, an image frame 830 captured at 55.5 ms according to the second capture setting 745, an image frame 835 captured at 66.6 ms according to the first capture setting 740, an image frame 840 captured at 77.7 ms according to the first capture setting 740, and an image frame 845 captured at 88.8 ms according to the second capture setting 745. In some examples, the image frames may be captured by the multi-domain image sensor after detection of a low-light scenario (scene) by the multi-domain image sensor (e.g., by an image processor 150 configured to adjust autofocus, autoexposure, and/or auto-white-balance).

An imaging system (e.g., the blending engine 230) generates a blended image 850 from the pixels in the first EM frequency domain 260 of the image frame 805, the image frame 810, and the image frame 815. The imaging system (e.g., the cross-domain contamination reduction engine 245) generates an output image 865 by subtracting adjustment values (that are based on the pixel values in the second EM frequency domain 265 of the image frame 815) from the pixel values of the blended image 850.

The imaging system (e.g., the blending engine 230) generates a blended image 855 from the pixels in the first EM frequency domain 260 of the image frame 820, the image frame 825, and the image frame 830. The imaging system (e.g., the cross-domain contamination reduction engine 245) generates an output image 870 by subtracting adjustment values (that are based on the pixel values in the second EM frequency domain 265 of the image frame 830) from the pixel values of the blended image 855.

The imaging system (e.g., the blending engine 230) generates a blended image 860 from the pixels in the first EM frequency domain 260 of the image frame 835, the image frame 840, and the image frame 845. The imaging system (e.g., the cross-domain contamination reduction engine 245) generates an output image 875 by subtracting adjustment values (that are based on the pixel values in the second EM frequency domain 265 of the image frame 845) from the pixel values of the blended image 860.

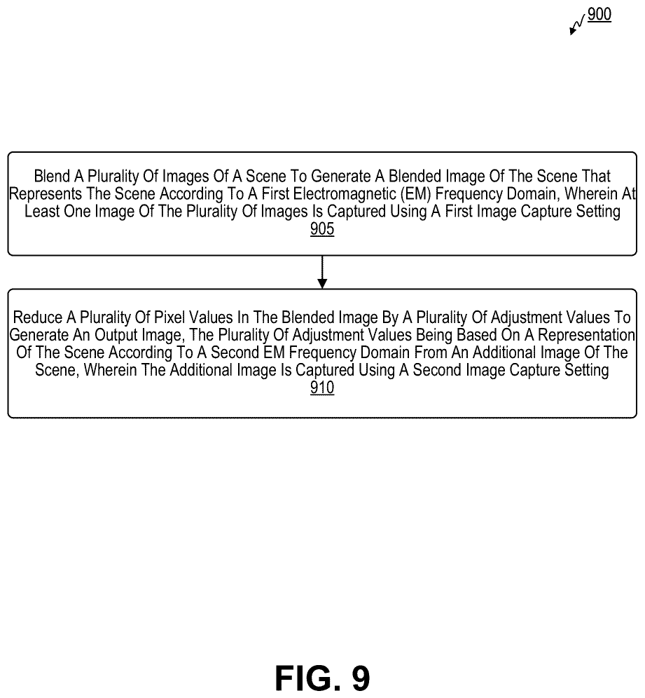

FIG. 9 is a flow diagram illustrating an imaging process 900. The imaging process 900 may be performed by an imaging system. In some examples, the imaging system can include, for example, the image capture and processing system 100, the image capture device 105A, the image processing device 105B, the image processor 150, the ISP 154, the host processor 152, the imaging system 200, the multi-domain image sensor 205, the image processor 215, the blending engine 230, the cross-domain contamination reduction engine 245, the output device(s) 255, the HMD 310, the mobile handset 410, the multi-domain image sensor 500, the imaging system 600, the computing system 1000, the processor 1010, or a combination thereof.

At operation 905, the imaging system is configured to, and can, blend (e.g., using the blending engine 230, the blended image 655, the blended image 665, and/or the blended image 680) a plurality of images of a scene to generate a blended image of the scene that represents the scene according to a first electromagnetic (EM) frequency domain. At least one image of the plurality of images is captured using a first image capture setting (e.g., first image capture settings 270).

In some aspects, the plurality of images and the additional image are captured using an image sensor. Examples of the image sensor includes the image sensor 130, the multi-domain image sensor 205, the first camera 330A, the second camera 330B, the third camera 330C, the fourth camera 330D, the first camera 430A, the second camera 430B, the third camera 430C, the fourth camera 430D, the multi-domain image sensor 500, the dual-domain image sensor 602, an image sensor that captures any of the image frames 705-730 of FIG. 7, an image sensor that captures any of the image frames 805-845 of FIG. 8, an image sensor of an input device 1045, another image sensor described herein, another sensor described herein, or a combination thereof. In some aspects, the image sensor includes a first set of photodetectors configured to be sensitive to the first EM frequency domain (e.g., the first EM frequency domain 260) and a second set of photodetectors configured to be sensitive to the second EM frequency domain (e.g., the second EM frequency domain 265), as in the multi-domain image sensor 205, the multi-domain image sensor 500, and/or the dual-domain image sensor 602.

Examples of the plurality of images of the scene include image data captured using the image capture and processing system 100, the multi-domain images 210, the image(s) 220 in the first EM frequency domain 260, the image data captured using the first camera 330A, image data captured using the second camera 330B, image data captured using the third camera 330C, image data captured using the fourth camera 330D, image data captured using the first camera 430A, image data captured using the second camera 430B, image data captured using the third camera 430C, image data captured using the fourth camera 430D, image data captured using the multi-domain image sensor 500, the dual-domain raw image data 605, the images in FIG. 6 captured in the first EM frequency domain 620 (e.g., in the red 630, green 632, and blue 635 channels), the image frame 705, the image frame 715, the image frame 725, the image frame 805, the image frame 810, the image frame 820, the image frame 825, the image frame 835, the image frame 840, or a combination thereof.

Examples of the blended image include the blended image 235 in the first EM frequency domain 260, the blended image 240 in the second EM frequency domain 265, the output image 660 generated using the blended image 655, the output image 670 generated using the blended image 665, the output image(s) 650 (and/or an intermediate blended image) generated using the blended image 680, the blended image 750, the blended image 755, the blended image 760, the blended image 850, the blended image 855, the blended image 860, another blended image discussed herein, or a combination thereof.

In some aspects, the at least one image of the plurality of images includes a second plurality of images captured using the first image capture setting. For instance, the second plurality of images can include frames 805-810, frames 820-825, or frames 835-840. In some aspects, the at least one image of the plurality of images includes only a single image captured using the first image capture setting. For instance, the single image can include frame 705, frame 715, or frame 725.

At operation 910, the imaging system is configured to, and can, reduce a plurality of pixel values in the blended image by a plurality of adjustment values to generate an output image. The plurality of adjustment values are based on a representation of the scene according to a second EM frequency domain from an additional image of the scene. The additional image is captured using a second image capture setting (e.g., the second image capture settings 275).

In some aspects, the first EM frequency domain includes at least a portion of a visible light EM frequency domain and the second EM frequency domain includes at least a portion of an infrared (IR) EM frequency domain, as suggested in FIG. 2 and as illustrated in FIG. 6. In some aspects, the first EM frequency domain includes at least a portion of an infrared (IR) EM frequency domain, and wherein the second EM frequency domain includes at least a portion of a visible light EM frequency domain.

Examples of the additional image of the scene include image data captured using the image capture and processing system 100, the multi-domain images 210, the image(s) 225 in the second EM frequency domain 265, the blended image 240 in the second EM frequency domain 265, the image data captured using the first camera 330A, image data captured using the second camera 330B, image data captured using the third camera 330C, image data captured using the fourth camera 330D, image data captured using the first camera 430A, image data captured using the second camera 430B, image data captured using the third camera 430C, image data captured using the fourth camera 430D, image data captured using the multi-domain image sensor 500, the dual-domain raw image data 605, the images in FIG. 6 captured in the second EM frequency domain 625 (e.g., infrared), the image frame 710, the image frame 720, the image frame 730, the image frame 815, the image frame 830, the image frame 845, or a combination thereof.

Examples of the plurality of adjustment values include a. IR from Equation 1, b. IR from Equation 2, c·IR from Equation 3, values subtracted from the blended image 235 using the cross-domain contamination reduction engine 245 (e.g., based on the image(s) 225 and/or the blended image 240) to generate the output image 250, values subtracted from the blended image 680 using the cross-domain contamination reduction 640 (e.g., based on the image in the second EM frequency domain 625 and/or the blended image blended image 665 (e.g., a×IR, b×IR, and/or c×IR) to generate the output image 650, values subtracted from the blended image 750 using the cross-domain contamination reduction engine 245 (e.g., based on the image frame 710) to generate the output image 765, values subtracted from the blended image 755 using the cross-domain contamination reduction engine 245 (e.g., based on the image frame 720) to generate the output image 770, values subtracted from the blended image 760 using the cross-domain contamination reduction engine 245 (e.g., based on the image frame 730) to generate the output image 775, values subtracted from the blended image 850 using the cross-domain contamination reduction engine 245 (e.g., based on the image frame 815) to generate the output image 865, values subtracted from the blended image 855 using the cross-domain contamination reduction engine 245 (e.g., based on the image frame 830) to generate the output image 870, values subtracted from the blended image 860 using the cross-domain contamination reduction engine 245 (e.g., based on the image frame 845) to generate the output image 875, or a combination thereof.

Examples of the output image include the output image 250, an output image that is output using the output device(s) 255, an output image displayed using the display(s) 340, an output image displayed using the display 440, the output image(s) 650, the output image 660, the output image 670, the output image 765, the output image 770, the output image 775, the output image 865, the output image 870, the output image 875, an output image output using the output device 1035, an output image output using the communication interface 1040, or a combination thereof.

In some aspects, the first image capture setting includes a first ISO setting and the second image capture setting includes a second ISO setting. In some aspects, the second ISO setting is lower than the first ISO setting.

In some aspects, the plurality of images includes the at least one image and a representation of the scene according to the first EM frequency domain in the additional image. Thus, the blended image can be blended based on the additional image as well as the other images in the plurality of images, as in FIG. 7 and FIG. 8. In some aspects, the additional image is distinct from the plurality of images, so that the blended image is blended using images other than the additional image.

In some aspects, the plurality of adjustment values are products of a coefficient and respective pixel values of the representation of the scene according to the second EM frequency domain from the additional image of the scene.

In some aspects, the first image capture setting includes a first exposure setting and the second image capture setting includes a second exposure setting. In some aspects, the first image capture setting includes a first focus setting and the second image capture setting includes a second focus setting. In some aspects, the first image capture setting includes a first white balance setting and the second image capture setting includes a second white balance setting. In some aspects, the first image capture setting includes a first setting for a given property of an ISP 154 (e.g., ISO, exposure time, aperture size, focus, white balance, or black balance) and the second image capture setting includes a second setting for the given property of the ISP 154. In some aspects, the first image capture setting includes a first combination of settings (e.g., ISO, exposure time, aperture size, focus, white balance, and/or black balance) and the second image capture setting includes a second combination of settings.

In some aspects, the imaging system is configured to, and can, output the output image (e.g., to memory, to storage, to output device(s) 255, to an output device 1035, to a communication interface 1040, or a combination thereof). In some aspects, the imaging system is configured to, and can, cause display of the output image using a display (e.g., output device(s) 255 and/or output device 1035). In some aspects, the imaging system is configured to, and can, cause transmission of the output image to a recipient device using a communication interface (e.g., output device(s) 255, output device 1035, and/or communication interface 1040).

In some examples, the processes described herein (e.g., the respective processes of FIGS. 1, 2, 6, 7, 8, the imaging process 900, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the imaging system 200, the multi-domain image sensor 205, the image processor 215, the blending engine 230, the cross-domain contamination reduction engine 245, the output device(s) 255, the HMD 310, the mobile handset 410, the multi-domain image sensor 500, the imaging system 600, an imaging system that performs the imaging process 900, the computing system 1000, the processor 1010, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

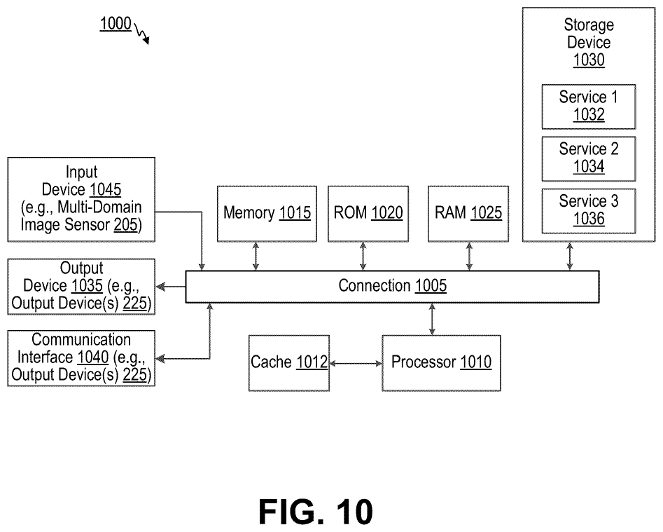

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1002.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for determining one or more image settings, the apparatus comprising: at least one memory; and at least one processor coupled to the at least one memory, the at least one processor configured to: blend a plurality of images of a scene to generate a blended image of the scene that represents the scene according to a first electromagnetic (EM) frequency domain, wherein at least one image of the plurality of images is captured using a first image capture setting; and reduce a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

Aspect 2. The apparatus of Aspect 1, wherein the first EM frequency domain includes at least a portion of a visible light EM frequency domain, and wherein the second EM frequency domain includes at least a portion of an infrared (IR) EM frequency domain.

Aspect 3. The apparatus of any of Aspects 1 to 2, wherein the first EM frequency domain includes at least a portion of an infrared (IR) EM frequency domain, and wherein the second EM frequency domain includes at least a portion of a visible light EM frequency domain.

Aspect 4. The apparatus of any of Aspects 1 to 3, wherein the plurality of images and the additional image are captured using an image sensor.

Aspect 5. The apparatus of Aspect 4, wherein the image sensor includes a first set of photodetectors configured to be sensitive to the first EM frequency domain and a second set of photodetectors configured to be sensitive to the second EM frequency domain.

Aspect 6. The apparatus of any of Aspects 1 to 5, wherein the first image capture setting includes a first ISO setting and the second image capture setting includes a second ISO setting.

Aspect 7. The apparatus of Aspect 6, wherein the second ISO setting is lower than the first ISO setting.

Aspect 8. The apparatus of any of Aspects 1 to 7, wherein the plurality of images includes the at least one image and a representation of the scene according to the first EM frequency domain in the additional image.

Aspect 9. The apparatus of any of Aspects 1 to 8, wherein the at least one image of the plurality of images includes a second plurality of images captured using the first image capture setting.

Aspect 10. The apparatus of any of Aspects 1 to 9, wherein the plurality of adjustment values are products of a coefficient and respective pixel values of the representation of the scene according to the second EM frequency domain from the additional image of the scene.

Aspect 11. The apparatus of any of Aspects 1 to 10, wherein the first image capture setting includes a first exposure setting and the second image capture setting includes a second exposure setting.

Aspect 12. The apparatus of any of Aspects 1 to 11, wherein the first image capture setting includes a first focus setting and the second image capture setting includes a second focus setting.

Aspect 13. The apparatus of any of Aspects 1 to 12, wherein the first image capture setting includes a first white balance setting and the second image capture setting includes a second white balance setting.

Aspect 14. The apparatus of any of Aspects 1 to 13, wherein the at least one processor is configured to: output the output image.

Aspect 15. The apparatus of any of Aspects 1 to 14, further comprising: a display configured to display the output image.

Aspect 16. The apparatus of any of Aspects 1 to 15, further comprising: a communication transceiver configured to transmit the output image to a recipient device.

Aspect 17. The apparatus of any of Aspects 1 to 16, wherein the apparatus includes at least one of a head-mounted display (HMD), a mobile handset, or a wireless communication device.

Aspect 18. A method for determining one or more image settings, the method comprising: blending a plurality of images of a scene to generate a blended image of the scene that represents the scene according to a first electromagnetic (EM) frequency domain, wherein at least one image of the plurality of images is captured using a first image capture setting; and reducing a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

Aspect 19. The method of Aspect 18, wherein the first EM frequency domain includes at least a portion of a visible light EM frequency domain, and wherein the second EM frequency domain includes at least a portion of an infrared (IR) EM frequency domain.

Aspect 20. The method of any of Aspects 18 to 19, wherein the first EM frequency domain includes at least a portion of an infrared (IR) EM frequency domain, and wherein the second EM frequency domain includes at least a portion of a visible light EM frequency domain.

Aspect 21. The method of any of Aspects 18 to 20, wherein the plurality of images and the additional image are captured using an image sensor.

Aspect 22. The method of Aspect 21, wherein the image sensor includes a first set of photodetectors configured to be sensitive to the first EM frequency domain and a second set of photodetectors configured to be sensitive to the second EM frequency domain.

Aspect 23. The method of any of Aspects 18 to 22, wherein the first image capture setting includes a first ISO setting and the second image capture setting includes a second ISO setting.

Aspect 24. The method of Aspect 23, wherein the second ISO setting is lower than the first ISO setting.

Aspect 25. The method of any of Aspects 18 to 24, wherein the plurality of images includes the at least one image and a representation of the scene according to the first EM frequency domain in the additional image.

Aspect 26. The method of any of Aspects 18 to 25, wherein the at least one image of the plurality of images includes a second plurality of images captured using the first image capture setting.

Aspect 27. The method of any of Aspects 18 to 26, wherein the plurality of adjustment values are products of a coefficient and respective pixel values of the representation of the scene according to the second EM frequency domain from the additional image of the scene.

Aspect 28. The method of any of Aspects 18 to 27, wherein the first image capture setting includes a first exposure setting and the second image capture setting includes a second exposure setting.

Aspect 29. The method of any of Aspects 18 to 28, wherein the first image capture setting includes a first focus setting and the second image capture setting includes a second focus setting.

Aspect 30. The method of any of Aspects 18 to 29, wherein the first image capture setting includes a first white balance setting and the second image capture setting includes a second white balance setting.

Aspect 31. The method of any of Aspects 18 to 30, further comprising: outputting the output image.

Aspect 32. The method of any of Aspects 18 to 31, further comprising: causing display of the output image using a display.

Aspect 33. The method of any of Aspects 18 to 32, further comprising: causing transmission of the output image to a recipient device using a communication interface.

Aspect 34. The method of any of Aspects 18 to 33, wherein the method is performed using an apparatus that includes at least one of a head-mounted display (HMD), a mobile handset, or a wireless communication device.

Aspect 35. A non-transitory computer-readable medium having stored thereon instructions that, when executed by one or more processors, cause the one or more processors to perform operations according to any of Aspects 1-34.

Aspect 36. An apparatus for image processing, the apparatus comprising one or more means for performing operations according to any of Aspects 1-34.

What is claimed is:

1. An apparatus for determining one or more image settings, the apparatus comprising:
at least one memory; and
at least one processor coupled to the at least one memory, the at least one processor configured to:
blend a plurality of images of a scene to generate a blended image of the scene that represents the scene according to a first electromagnetic (EM) frequency domain, wherein at least one image of the plurality of images is captured using a first image capture setting; and
reduce a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

2. The apparatus of claim 1, wherein the first EM frequency domain includes at least a portion of a visible light EM frequency domain, and wherein the second EM frequency domain includes at least a portion of an infrared (IR) EM frequency domain.

3. The apparatus of claim 1, wherein the first EM frequency domain includes at least a portion of an infrared (IR) EM frequency domain, and wherein the second EM frequency domain includes at least a portion of a visible light EM frequency domain.

4. The apparatus of claim 1, wherein the plurality of images and the additional image are captured using an image sensor.

5. The apparatus of claim 4, wherein the image sensor includes a first set of photodetectors configured to be sensitive to the first EM frequency domain and a second set of photodetectors configured to be sensitive to the second EM frequency domain.

6. The apparatus of claim 1, wherein the first image capture setting includes a first ISO setting and the second image capture setting includes a second ISO setting.

7. The apparatus of claim 6, wherein the second ISO setting is lower than the first ISO setting.

8. The apparatus of claim 1, wherein the plurality of images includes the at least one image and a representation of the scene according to the first EM frequency domain in the additional image.

9. The apparatus of claim 1, wherein the at least one image of the plurality of images includes a second plurality of images captured using the first image capture setting.

10. The apparatus of claim 1, wherein the plurality of adjustment values are products of a coefficient and respective pixel values of the representation of the scene according to the second EM frequency domain from the additional image of the scene.

11. The apparatus of claim 1, wherein the first image capture setting includes a first exposure setting and the second image capture setting includes a second exposure setting.

12. The apparatus of claim 1, wherein the first image capture setting includes a first focus setting and the second image capture setting includes a second focus setting.

13. The apparatus of claim 1, wherein the first image capture setting includes a first white balance setting and the second image capture setting includes a second white balance setting.

14. The apparatus of claim 1, wherein the at least one processor is configured to:
output the output image.

15. The apparatus of claim 1, further comprising:
a display configured to display the output image.

16. The apparatus of claim 1, further comprising:
a communication transceiver configured to transmit the output image to a recipient device.

17. The apparatus of claim 1, wherein the apparatus includes at least one of a head-mounted display (HMD), a mobile handset, or a wireless communication device.

18. A method for determining one or more image settings, the method comprising:
blending a plurality of images of a scene to generate a blended image of the scene that represents the scene according to a first electromagnetic (EM) frequency domain, wherein at least one image of the plurality of images is captured using a first image capture setting; and
reducing a plurality of pixel values in the blended image by a plurality of adjustment values to generate an output image, the plurality of adjustment values being based on a representation of the scene according to a second EM frequency domain from an additional image of the scene, wherein the additional image is captured using a second image capture setting.

19. The method of claim 18, wherein the first EM frequency domain includes at least a portion of a visible light EM frequency domain, and wherein the second EM frequency domain includes at least a portion of an infrared (IR) EM frequency domain.

20. The method of claim 18, wherein the first EM frequency domain includes at least a portion of an infrared (IR) EM frequency domain, and wherein the second EM frequency domain includes at least a portion of a visible light EM frequency domain.

21. The method of claim 18, wherein the plurality of images and the additional image are captured using an image sensor.

22. The method of claim 18, wherein the first image capture setting includes a first ISO setting and the second image capture setting includes a second ISO setting.

23. The method of claim 22, wherein the second ISO setting is lower than the first ISO setting.

24. The method of claim 18, wherein the plurality of images includes the at least one image and a representation of the scene according to the first EM frequency domain in the additional image.

25. The method of claim 18, wherein the at least one image of the plurality of images includes a second plurality of images captured using the first image capture setting.

26. The method of claim 18, wherein the plurality of adjustment values are products of a coefficient and respective pixel values of the representation of the scene according to the second EM frequency domain from the additional image of the scene.

27. The method of claim 18, wherein the first image capture setting includes a first exposure setting and the second image capture setting includes a second exposure setting.

28. The method of claim 18, wherein the first image capture setting includes a first focus setting and the second image capture setting includes a second focus setting.

29. The method of claim 18, wherein the first image capture setting includes a first white balance setting and the second image capture setting includes a second white balance setting.

30. The method of claim 18, further comprising:
outputting the output image.
